(19) United States
(12) Patent Application Publication
(10) Pub. No.: US 2019/0279268 A1
(43) Pub. Date: Sep. 12, 2019

(54) METHOD FOR CONDUCTING BUSINESS TO ENABLE A CUSTOMER TO SUPPORT A CAUSE BY CREATING A CUSTOMIZED FLOWER ORNAMENT OR BOUQUET USING THE CAUSE TO SELECT FROM AMONG COLORS AND/OR COLOR PATTERNS OF AT LEAST ONE REAL AND/OR ARTIFICIAL FLOWER

(71) Applicant: Sheila Marshall, Fort Eustis, VA (US)

(72) Inventor: Sheila Marshall, Fort Eustis, VA (US)

(21) Appl. No.: 15/915,671

(22) Filed: Mar. 8, 2018

(51) Int. Cl. G06Q 30/06

(52) U.S. Cl. CPC G06Q 30/0621; G06Q 30/0643

(57) ABSTRACT

A method for conducting business to enable a Customer to support a cause by creating a customized flower ornament and/or bouquet. The method includes: asking the Customer for which cause they are purchasing the customized flower ornament and/or bouquet, and then using the cause to select corresponding color(s) or color pattern of at least one real and/or artificial flower(s) to be used; asking the Customer to select a flower type of the real and/or artificial flower(s); asking the Customer to indicate whether photo(s) will be combined with the real and/or artificial flower(s); asking the Customer whether the photo(s) will be framed; and asking the Customer whether a ribbon will be appended to the real and/or artificial flower(s). Using the cause to select corresponding colors or a color pattern includes: using a lookup table including many causes, each cause being associated with one or more colors, and/or with a color pattern.

### FIELD OF THE INVENTION

This invention relates generally to methods for supporting a cause, and more particularly to methods for supporting a cause by helping customers to create customized flower-based ornaments and/or flower bouquets.

### BACKGROUND OF THE INVENTION

Roses for Autism is a cause-related floral option focused on only one cause, the cause of autism.

Patriot Pin-Ups, a female volunteer support group for American veterans, uses hair flowers for their cause, but uses only red, white, and blue flowers.

The Flowers for Disease Project, on the other hand, does color-code for multiple causes. However, it does so only for diseases, and it only provides one flower/color at a time for each month's featured disease. So, at any given time, only one color-coded option—related to only one particular cause—is made available.

Michelle Eier teaches a personalized floral keepsake (US Patent Application No. 20130273269A1) that allows for personalized messages on each petal of a simulated flower. The invention provides a heartfelt personalized durable keepsake bearing a message. Essentially, it serves the same function as a greeting card.

While not a cause-related floral service per se, Ribbon Tribute is notable for using color-coding to match ribbons to causes, according to the colors associated with each cause. However, it does not combine its ribbons with any flowers, color-coded or otherwise.

### SUMMARY OF THE INVENTION

The present invention provides a method for helping those eager to support a particular cause. In some embodiments, the method helps to create a customized flower ornament and/or bouquet that supports a cause. In further embodiments, the flower ornament can be customized so as to also honor a loved one. More specifically, the method of the invention is a method for conducting business by creating a flower ornament and/or bouquet featuring a color or color pattern that represents one of a plurality of selectable causes. The flower ornament and/or bouquet can be further customized with a personal dedication, among other customizable options. Further, the flower(s) can be selected to be a real flower or flowers, or an artificial flower or flowers, so as to further enhance the symbolism and poignancy of each customized flower ornament and/or bouquet.

A general aspect of the invention is a method for conducting business with a Customer so as to enable the Customer to support a cause by creating a customized flower ornament. The method includes: asking the Customer for which medical, social, or other cause they are purchasing the customized flower ornament; using the cause to select a corresponding one or more colors, or a color pattern of at least one real and/or artificial flower(s) to be used to create the customized flower ornament and/or bouquet; asking the Customer to select a flower type of the real and/or artificial flower(s) from a set including: rose, violet, tulip, etc.; asking the Customer to indicate whether a photo or photos and/or frame will be combined with the real and/or artificial flower(s); asking the Customer whether the photo(s) will be framed; and asking the Customer whether a ribbon will be appended to the real and/or artificial flower(s).

In some embodiments, using the cause to select includes: using a lookup table including a plurality of causes, each cause being associated with one or more colors, or a color pattern.

In some embodiments, if the Customer indicates that a photo or photos will be combined with the real and/or artificial flower(s), the Customer will be asked to send an original/hard copy—or provide via e-mail a digital version—of the desired photo(s) of the Customer's beloved person(s) or pet(s).

In some embodiments, the selected photo(s) is/are printed and attached to the real and/or artificial flower(s).

In some embodiments, the selected photo(s) is/are attached to the real and/or artificial flower(s) using a string or a chain or another method.

In some embodiments, if the photo(s) is/are to be framed, asking the Customer the size and type of the frame desired.

In some embodiments, if the ribbon is to be appended to the real and/or artificial flower(s), asking the Customer the type of ribbon, and asking the Customer what will be written on the ribbon, if writing on the ribbon is desired.

In some embodiments, the method further includes possibly donating a certain percentage of each sale to the cause.

In some embodiments, possibly donating a certain percentage of each sale to the cause includes contributing to a charitable organization that advocates for that particular cause.

### BRIEF DESCRIPTION OF THE INVENTION

Many additional features and advantages will become apparent to those skilled in the art upon reading the following description, when considered in conjunction with the accompanying drawings, wherein:

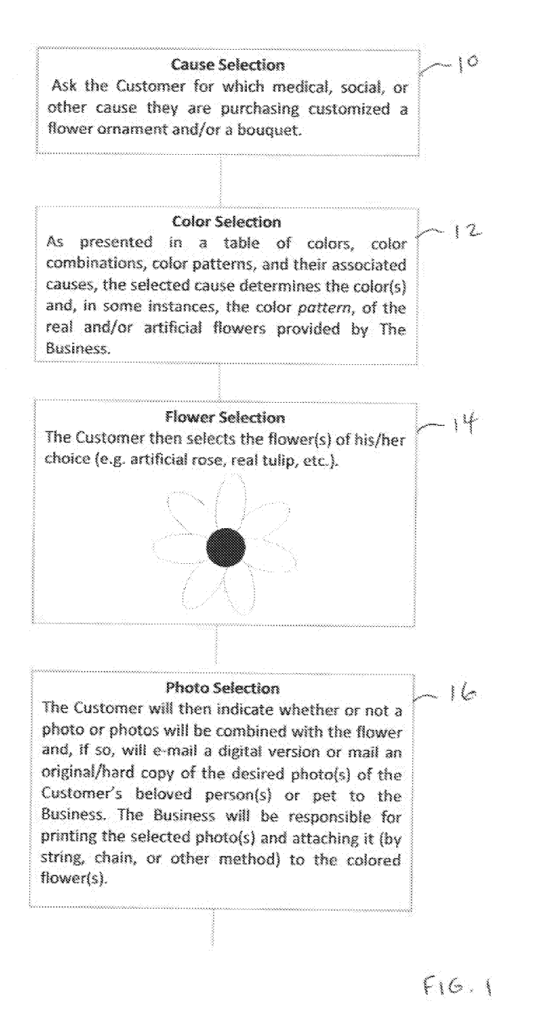

FIG. 1 is a block diagram showing some steps of the method; and

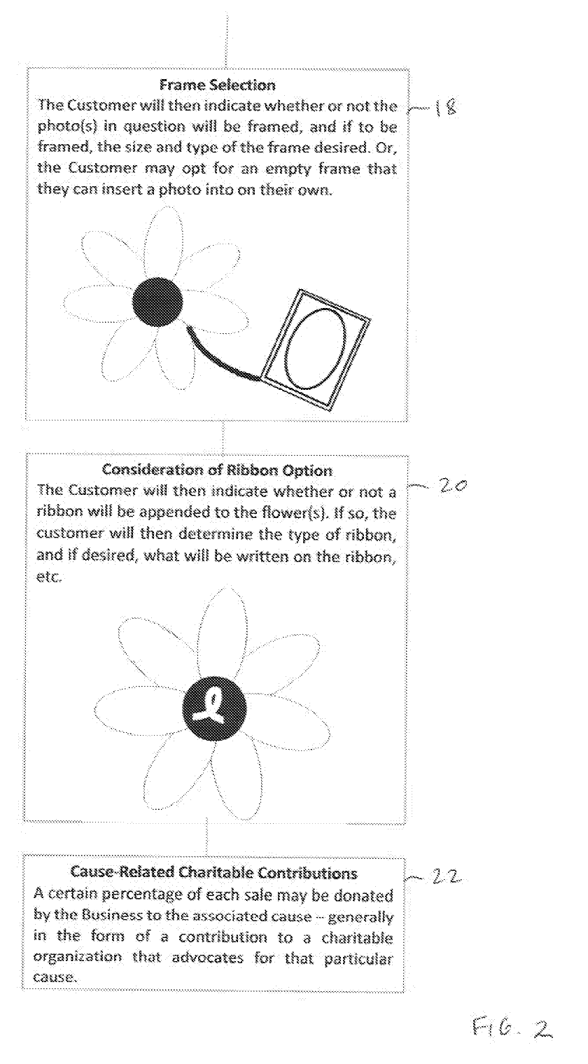

FIG. 2 is a block diagram showing some more steps of the method.

### DETAILED DESCRIPTION

Referring to FIGS. 1 and 2, a sequence of actions are presented, but the order of presentation is just one of many orders that the actions can be performed. An exception is the order of steps 10 and 12, wherein a cause is selected in step 10, which determines the color or color pattern to be used to represent the cause. This pair of steps 10 and 12 can be performed before all of the other steps. Alternatively, one or more of the other steps can be performed before steps 10 and 12, as long as step 10 is always performed before step 12.

Referring again to step 10, the customer is asked what cause they would like to support. To ensure the proper color and/or color pattern matching, it is imperative to determine the specific medical, social, or other cause that the customer has in mind to support. For example, pink is associated with breast cancer, but pink combined with blue is associated with inflammatory breast cancer. So, determining the cause with as much specificity as possible is essential to creating an appropriately colored flower ornament and/or bouquet.

Referring again to step 12, the selection of color is determined by the selection of the cause. Now that the specific cause has been selected, the associated color, color combination, or color pattern must be determined correctly. To this end, a table featuring an exhaustive list of causes and their associated colors, color combinations, and/or color patterns is used. Of course, some colors are best presented by certain natural flowers, while others can only be presented by an artificial flower, such as certain color combinations and patterns. So, color selection can be important when selecting the appropriate flower(s), which is set forth in step 14.

Referring to step 14, the customer must select a type of flower from a wide selection of both natural and artificial flowers. The customer is guided to select from among the flower types that can present the color of the cause initially selected. Further, some customers will have a strong preference for natural flowers, while others prefer the durability of artificial flowers. The selection of options must be comprehensive enough to suit all tastes and causes—e.g. artificial red rose, real yellow tulip, artificial orange and blue daffodil.

Referring to step 16, the customer must decide whether to select an accompanying photo(s) to accompany the flower(s). A photo or photos of a beloved person or pet to whom the flower ornament and/or bouquet is dedicated can be attached to the flower ornament and/or bouquet. If such an attachment is desired, the customer must either e-mail a digital version of the desired photo(s), or mail an original/hard copy to the business creating the customized flower ornament and/or bouquet. The business will then create a print of the photo(s) on durable photo paper sized to be suitable for presentation with the flower(s), and then attach it to the flower(s). The customer may select the method of attachment, e.g., using a string, a chain, a clip, or another connecting device.

Referring to step 18, the customer must decide whether the photo(s) is/are to be framed, and if so, select a particular frame. If the customer has opted to forego including a photo or photos, then step 18 is skipped. If the customer elects to include a photo or photos, but does not wish to have it framed, that request will be honored. Conversely, if the customer has chosen not to submit a photo or photos to the business, the customer can choose an empty frame into which they can insert a photo or photos later. However, those customers who would like to have their photo(s) framed will need to specify the size and type of frame (e.g. brass, wood, etc.) (fancy, simple, modern old-fashioned, etc.).

Referring to step 20, the customer must decide whether to include a ribbon. If the customer decides to have a ribbon presented along with the flower, the type of ribbon and the content of the message (if any) printed on the ribbon must be specified by the customer. Especially since many causes are already associated with different types of ribbons, the inclusion of a ribbon further strengthens the ornament's and/or bouquet's association with the selected cause, and also enhances the overall presentation of the ornament.

Referring to step 22, this optional step of the method involves the business facilitating charitable contributions to the customer's causes. With the customer's consent, a certain percentage of the amount paid to the business for purchasing the customized flower ornament and/or bouquet will be donated to a charitable organization, perhaps selected by the business owner, that advocates for the customer's cause. For example, a family that purchases an ornament pertaining to Parkinson's disease may elect to have their contribution sent to a charity selected by the business owner that is related to Parkinson's Research. This optional step 22 is intended to make the experience of buying the customized flower ornament and/or bouquet more impactful for customers. Through such contributions, beyond specifying and purchasing a beautiful ornament that signifies a customer's solidarity with a particular cause, the customer is also providing a tangible form of support to that cause.

Other modifications and implementations will occur to those skilled in the art without departing from the spirit and the scope of the invention as claimed. Accordingly, the above description is not intended to limit the invention, except as indicated in the following claims.

What is claimed is:

1. A method for conducting business with a Customer so as to enable the Customer to support a cause by creating a customized flower ornament and/or bouquet, the method comprising:
asking the Customer for which medical, social, or other cause they are purchasing the customized flower ornament and/or bouquet;
using the cause to select a corresponding one or more colors, or a color pattern of at least one real and/or artificial flower(s) to be used to create the customized flower ornament and/or bouquet;
asking the Customer to select a flower type of the real and/or artificial flower(s) from a set including: rose, violet, tulip, mixed flowers, etc.;
asking the Customer to indicate whether a photo or photos, and/or frame will be combined with the real and/or artificial flower(s);
asking the Customer whether the photo(s) will be framed; and
asking the Customer whether a ribbon will be appended to the real and/or artificial flower(s).

2. The method of claim 1, wherein using the cause to select includes:
using a lookup table including a plurality of causes, each cause being associated with one or more colors, or a color pattern.

3. The method of claim 1, wherein if the Customer indicates that a photo or photos will be combined with the real and/or artificial flower(s), the Customer will be asked to send an original/hard copy—or provide via e-mail a digital version—of the desired photo(s) of the Customer's beloved person(s) or pet(s).

4. The method of claim 3, wherein the selected photo(s) is/are printed and attached to the real and/or artificial flower(s).

5. The method of claim 4, wherein the selected photo(s) is/are attached to the real and/or artificial flower(s) using a string or a chain or another method.

6. The method of claim 1, wherein if the photo(s) is/are to be framed, asking the Customer the size and type of the frame desired.

7. The method of claim 1, wherein if the ribbon is to be appended to the real and/or artificial flower(s), asking the Customer the type of ribbon, and asking the Customer what will be written, on the ribbon.

8. The method of claim 1, further comprising:
possibly donating a certain percentage of each sale to the cause.

9. The method of claim 8, wherein possibly donating a certain percentage of each sale to the cause includes contributing to a charitable organization that advocates for that particular cause.
